(19) United States
(12) Patent Application Publication
(10) Pub. No.: US 2018/0025096 A1
(43) Pub. Date: Jan. 25, 2018

(54) DATA REFERRING METHOD, INFORMATION PROCESSING APPARATUS, AND STORAGE MEDIUM

(71) Applicant: FUJITSU LIMITED, Kawasaki-shi (JP)

(72) Inventor: Ken Iizawa, Yokohama (JP)

(73) Assignee: FUJITSU LIMITED, Kawasaki-shi (JP)

(21) Appl. No.: 15/650,012

(22) Filed: Jul. 14, 2017

(30) Foreign Application Priority Data
Jul. 25, 2016 (JP) 2016-145361

(51) Int. Cl. G06F 17/30; H04N 21/433; H04N 21/84

(52) U.S. Cl. CPC G06F 17/30997; G06F 17/30964; H04N 21/84; H04N 21/4331; G06F 9/50

(57) ABSTRACT

A data referring method executed by a processor included in an information processing apparatus coupled to a network, a first memory, and a second memory, the data referring method includes writing sequentially stream data passing through the network on the first memory; writing index data used for retrieving the stream data written on the first memory, on the first memory and the second memory; specifying a memory with a high read speed of the index data between the first memory and the second memory when reading the index data; and reading the index data from the specified memory.

### CROSS-REFERENCE TO RELATED APPLICATION

This application is based upon and claims the benefit of priority of the prior Japanese Patent Application No. 2016-145361, filed on Jul. 25, 2016, the entire contents of which are incorporated herein by reference.

### FIELD

The embodiments discussed herein are related to a data referring method, an information processing apparatus, and a storage medium.

### BACKGROUND

There is a storage system (stream storage system) that accumulates data (stream data) which passes through a data transmission line such as a communication line every moment. For example, when performing packet capture for capturing packets passing through an internet protocol (IP) network and analyzing changes in traffic, the stream storage system is used for accumulation of packets to be analyzed.

In the stream storage system, index data is generated for retrieving accumulated stream data. The generated index data is stored in the same storage device where the stream data is stored. In the stream storage system, when reading the stream data, the index data corresponding to the stream data is referred to. Based on the index data, the stream data accumulated in the storage device is retrieved.

A method of using metadata for retrieving actual data has been proposed. In this method, a data providing apparatus provides metadata together with actual data. Then, metadata stored in advance in a data storage unit is compared with the metadata provided from the data providing apparatus, and the metadata in the data storage unit is updated according to the comparison result.

A method of using index data for retrieving image data has been proposed. In this method, index data as a key for access to image data is stored in a high-speed storage medium (index medium) and a large-capacity storage medium (image medium). When there is no suitable index data in the index medium, the index data in the image medium is used. As the related art, for example, Japanese Laid-open Patent Publication No. 2007-122643 and Japanese Laid-open Utility Model Publication No. 58-51360 are disclosed.

In the stream storage system, since the stream data which passes through a network every moment is accumulated in the storage device, a writing load on the storage device tends to be high. For this reason, when storing the index data in the storage device that accumulates the stream data, in a situation where the writing load of the stream data is high, it may take time to read the index data.

In the case of storing the index data in another storage device (index volume) different from the storage device (data volume) that accumulates the stream data, even in a situation where the writing load of the stream data is high, the index data may be read at high speed.

Here, for reasons such as desired performance and cost, in many cases, hardware with high access performance is used for the data volume as compared with hardware of the index volume. Thus, even in a case where the index volume is provided, there is room for improving reading performance of the index data, by using the data volume for storing the index data. In view of the above, it is desirable to improve the reading performance of the index data.

### SUMMARY

According to an aspect of the invention, a data referring method executed by a processor included in an information processing apparatus coupled to a network, a first memory, and a second memory, the data referring method includes writing sequentially stream data passing through the network on the first memory; writing index data used for retrieving the stream data written on the first memory, on the first memory and the second memory; specifying a memory with a high read speed of the index data between the first memory and the second memory when reading the index data; and reading the index data from the specified memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing apparatus according to a first embodiment;

FIG. 2 is a diagram illustrating an example of a stream storage system according to a second embodiment;

FIG. 3 is a sequence diagram illustrating a flow of stream data writing processing according to the second embodiment;

FIG. 4 is a diagram illustrating an example of a write request;

FIG. 5 is a diagram illustrating an example of index data;

FIG. 6 is a diagram illustrating an example of an index management table;

FIG. 7 is a diagram for explaining a writing method of the index data according to the second embodiment;

FIG. 8 is a block diagram illustrating an example of hardware which may realize functions of a client apparatus according to the second embodiment;

FIG. 9 is a block diagram illustrating an example of functions of a server apparatus according to the second embodiment;

FIG. 10 is a flowchart illustrating a flow of processing related to management of the index data according to the second embodiment;

FIG. 11 is a first flowchart illustrating a flow of processing related to retrieval of event data according to the second embodiment;

FIG. 12 is a second flowchart illustrating the flow of processing related to retrieval of the event data according to the second embodiment;

FIG. 13 is a diagram illustrating an example of a retrieval request; and

FIG. 14 is a flowchart illustrating a flow of processing related to generation of speed information according to the second embodiment.

### DESCRIPTION OF EMBODIMENTS

Hereinafter, embodiments discussed herein will be described with reference to the accompanying drawings. In the present specification and drawings, components having substantially the same functions are denoted by the same reference numerals, and repeated descriptions thereof may be omitted.

### First Embodiment

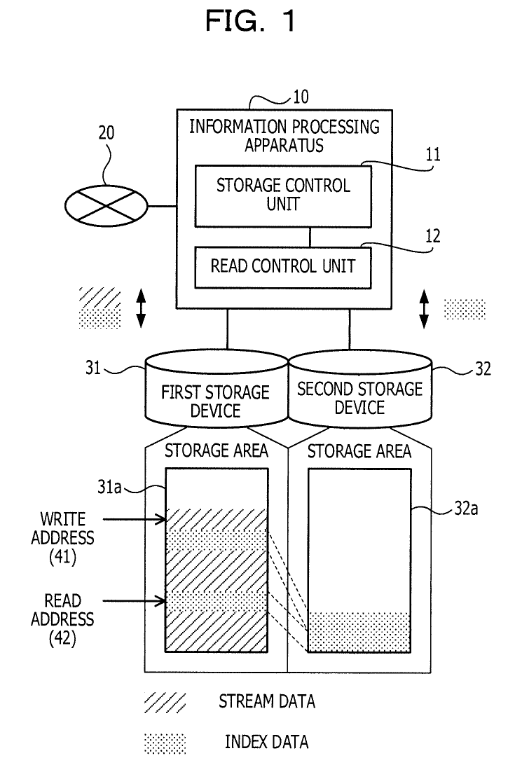

A first embodiment will be described with reference to FIG. 1. The first embodiment is related to a stream storage system capable of, at high speed, reading index data which is used for retrieving stream data. FIG. 1 is a diagram illustrating an example of an information processing apparatus according to the first embodiment. An information processing apparatus 10 illustrated in FIG. 1 is an example of the information processing apparatus according to the first embodiment.

As illustrated in FIG. 1, the information processing apparatus 10 includes a storage control unit 11 and a read control unit 12. The information processing apparatus 10 is connected to a network 20. The information processing apparatus 10 is connected to a first storage device 31 and a second storage device 32.

The information processing apparatus 10 includes a volatile storage device (not illustrated) such as a random access memory (RAM), or a nonvolatile storage device (not illustrated) such as a hard disk drive (HDD) or a solid state drive (SSD). The storage control unit 11 and the read control unit 12 are processors such as a central processing unit (CPU), a digital signal processor (DSP), an application specific integrated circuit (ASIC), or a field programmable gate array (FPGA). The storage control unit 11 and the read control unit 12 execute a program stored in, for example, a RAM or an HDD.

The first storage device 31 and the second storage device 32 are storage devices such as an HDD or an SSD. The first storage device 31 and the second storage device 32 may be redundant arrays of inexpensive disks (RAID) devices each in which a plurality of storage devices are combined to each other.

The first storage device 31 is a storage device used for storing data (stream data) passing through the network 20. On the other hand, the second storage device 32 is a storage device that is used for storing data (index data) which is used for retrieving stream data stored in the first storage device 31. Here, the index data is also stored in the first storage device 31.

The processing of writing of the stream data is a write-intensive workload. Thus, for the first storage device 31, for example, a RAID device which is set to RAID0 (striping) is used. A RAID device such as RAID5 in which parities are distributed and assigned to a plurality of HDDs, may be applied to the first storage device 31. On the other hand, writing performance of the second storage device 32 is less important than that of the first storage device 31. Thus, the second storage device 32 may be a storage device having lower reading and writing performance than that of the first storage device 31 under the same storage situation.

The storage control unit 11 writes the stream data on the first storage device 31. The storage control unit 11 writes the index data which is used for retrieving the stream data which is written on the first storage device 31, on the first storage device 31 and the second storage device 32. In the example of FIG. 1, the stream data and the index data are written on a storage area 31a of the first storage device 31. The same index data is written on a storage area 32a of the second storage device 32.

As described above, the storage control unit 11 writes the index data on both of the storage areas 31a and 32a. Thus, the read control unit 12 may read the index data from any of the storage areas 31a and 32a. When reading the index data, between the first storage device 31 and the second storage device 32, the read control unit 12 reads the index data from the storage device that may read the index data faster.

As described above, the stream data is written on the first storage device 31, and thus the first storage device 31 is often in a state of a high writing load. Thus, while the stream data is being written, when it is attempted to read the index data from the first storage device 31, it takes a long time to read the index data.

On the other hand, as the second storage device 32, a storage device having lower reading and writing performance than that of the first storage device 31, may be adopted. In this case, when a flow amount of the stream data written on the first storage device 31 is less, it may be faster to read the index data from the first storage device 31 than to read the index data from the second storage device 32. Thus, as described above, the read control unit 12 reads the index data from the storage device that may read the index data faster.

For example, the read control unit 12 calculates a distance between an address (write address 41) of the stream data currently being written on the first storage device 31 and an address (read address 42) of the index data in the first storage device 31. The write address 41 and the read address 42 are physical addresses or logical addresses in the first storage device 31. The read control unit 12 determines whether to read the index data from the first storage device 31 or to read the index data from the second storage device 32, based on the calculated distance.

As described above, depending on the application of the first storage device 31 and the second storage device 32, storage devices at different performance levels may be used. Thus, in the first embodiment, a method of storing the index data in both of the first storage device 31 and the second storage device 32 and reading the index data from the storage device that may read the index data faster, is adopted. According to application of the method, reading performance of the index data may be improved, and thus it is possible to retrieve the stream data at high speed.

### Second Embodiment

Next, a second embodiment will be described.

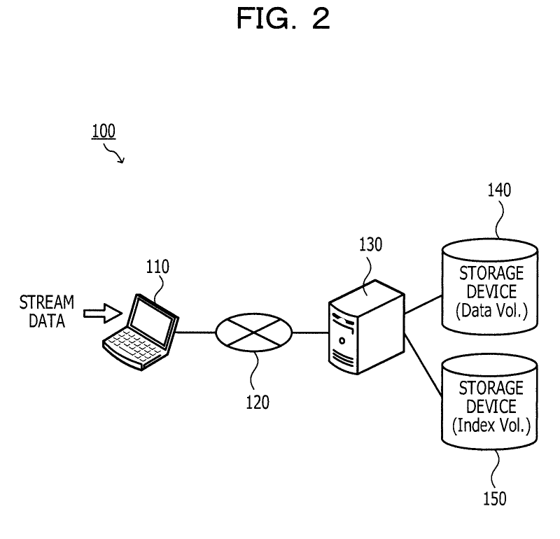

The second embodiment is related to a stream storage system capable of, at high speed, reading index data which is used for retrieving stream data. FIG. 2 is a diagram illustrating an example of a stream storage system according to the second embodiment. A stream storage system 100 illustrated in FIG. 2 is an example of the stream storage system according to the second embodiment.

As illustrated in FIG. 2, the stream storage system 100 includes a client apparatus 110, a server apparatus 130, and storage devices 140 and 150. The client apparatus 110 and the server apparatus 130 are connected to each other via a network 120. The client apparatus 110 and the server apparatus 130 are computers each on which a computation device such as a CPU and a memory such as a RAM are mounted, as will be described later. The network 120 is, for example, a communication network such as a local area network (LAN) or a wide area network (WAN).

The storage devices 140 and 150 are storage devices such as an HDD or an SSD, or RAID devices each in which a plurality of storage devices are combined to each other. The storage device 140 is a storage device that is used for storing stream data and index data which is used for retrieving the stream data. On the other hand, the storage device 150 is a storage device used for storing the index data. In the following description, for convenience of explanation, the storage device 140 may be referred to as a data volume, and the storage device 150 may be referred to as an index volume.

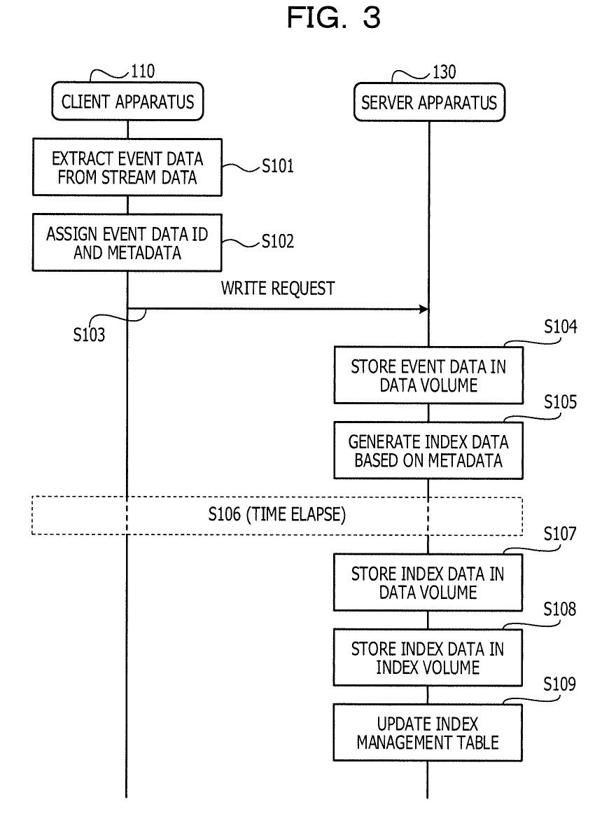

As described above, the stream storage system 100 is a system that accumulates the stream data to the data volume. The stream data is written on the data volume, for example, according to a flow as illustrated in FIG. 3. FIG. 3 is a sequence diagram illustrating a flow of stream data writing processing according to the second embodiment.

(S101) The client apparatus 110 captures stream data which passes through a wide area communication network such as the Internet and a local area communication network such as a LAN every moment. For example, the client apparatus 110 captures a packet (IP packet) passing through an IP network, as the stream data.

The client apparatus 110 extracts a data set (event data) having a common attribute, from the captured stream data. For example, the IP packet includes information such as a source IP address, a destination IP address, a protocol number (a number indicating a protocol type), and the like. As the attribute, the information (for example, a source IP address, a destination IP address, a protocol type) may be applied.

For example, the client apparatus 110 captures an IP packet as stream data, and extracts, among the captured IP packets, a set of IP packets having a common source IP address, a common destination IP address, and a common protocol type, as event data.

(S102) The client apparatus 110 assigns identification information (an event data ID) to the event data extracted in S101. The event data ID is identification information for uniquely specifying the corresponding event data. The client apparatus 110 assigns information (metadata) indicating the attribute of the event data to the event data.

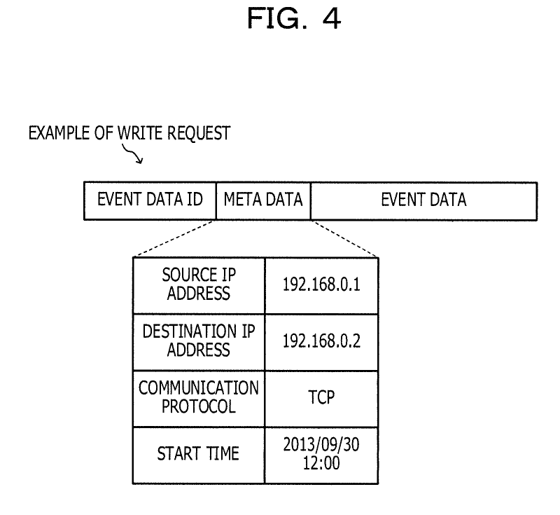

In the example of the IP packet described above, information indicating a source IP address, a destination IP address, a protocol type, and the like is assigned to the event data, as the metadata. The event data to which the event data ID and the metadata are assigned, may be hereinafter referred to as a write request. The write request has, for example, a structure as illustrated in FIG. 4. FIG. 4 is a diagram illustrating an example of the write request.

As illustrated in FIG. 4, the write request includes the event data ID, the metadata, and the event data. In the example of FIG. 4, in addition to a source IP address, a destination IP address, and a communication protocol (protocol type), a start time is included in the metadata. The start time is the time to start processing related to writing of the event data. The start time is, for example, the time to request writing of the event data to the server apparatus 130.

(S103) The client apparatus 110 transmits the write request to the server apparatus 130, and requests writing of the event data on the data volume.

(S104) The server apparatus 130 extracts the event data, from the write request received from the client apparatus 110. The server apparatus 130 stores the extracted event data in the data volume.

(S105) The server apparatus 130 extracts the metadata and the event data ID, from the write request received from the client apparatus 110. The server apparatus 130 generates index data which is used for retrieving the event data stored in the data volume, based on the extracted metadata. In a case where there is the index data before storing in the data volume and the index volume (in a case where the index data is present in a memory of the server apparatus 130), the server apparatus 130 updates the index data.

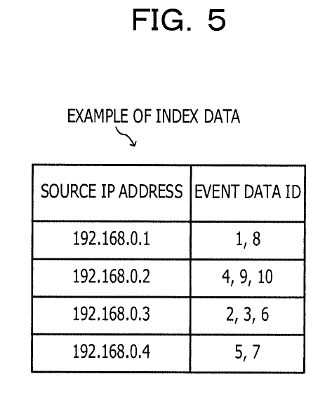

In a case where a retrieval key which is used for retrieving the event data is set as a source IP address, the index data has, for example, a structure as illustrated in FIG. 5. FIG. 5 is a diagram illustrating an example of the index data. In this case, the index data is correlated with the source IP address and the event data ID. In other words, by referring to the index data, it is possible to specify the event data corresponding to the designated source IP address.

(S106) As described above, the index data is stored in the data volume and the index volume. Here, the index data is stored, for example, at a timing when a predetermined time (for example, one hour) elapses after the index data is previously stored. In the server apparatus 130, storing of the index data is awaited until the time elapses.

Even during a period until the time elapses, the processes of S101 to S105 are continuously executed. For this reason, during the period until the predetermined time elapses, information such as a source IP address is continuously added to the index data.

(S107 and S108) At a timing when the predetermined time elapses, the server apparatus 130 stores the index data in the data volume. The server apparatus 130 stores, in the index volume, the same data as the index data stored in the data volume. The server apparatus 130 may firstly store the index data in the index volume.

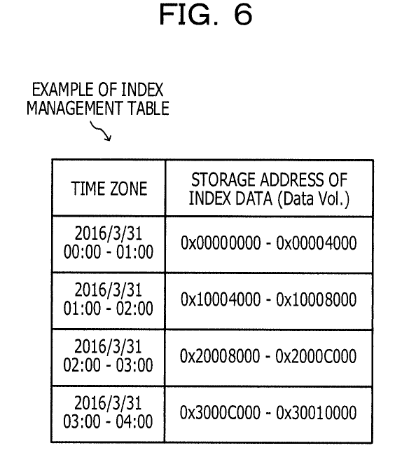

(S109) The server apparatus 130 updates an index management table for managing a storage position of the index data on the data volume. The index management table has, for example, a structure as illustrated in FIG. 6. FIG. 6 is a diagram illustrating an example of the index management table. As illustrated in FIG. 6, in the index management table, a time duration for which information is added to the index data is correlated with a storage address of the index data on the data volume.

As described above, the event data extracted by the client apparatus 110 is continuously transmitted to the server apparatus 130, and is stored in the data volume. The index data which is used for retrieving the event data is sequentially updated as the event data is stored. After a predetermined period of time elapses, the index data is stored in both of the data volume and the index volume. The index data stored in the data volume is managed by using the index management table.

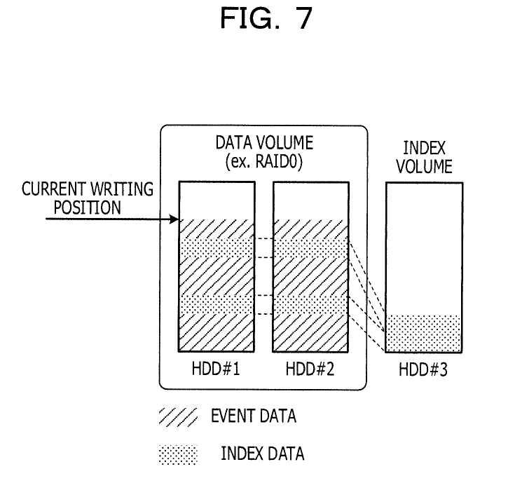

For example, in a case where the data volume is configured with HDD#1 and HDD#2 having a striping configuration (RAID0) and the index volume is configured with HDD#3, as illustrated in FIG. 7, the index data is stored in both of the data volume and the index volume. FIG. 7 is a diagram for explaining a writing method of the index data according to the second embodiment.

In FIG. 7, frames denoted by HDD#1, HDD#2, and HDD#3 respectively indicate storage areas of HDD#1, HDD#2, and HDD#3. A hatched portion with slashes indicates an area in which the event data is written. On the other hand, a non-hatched portion indicates an area in which the index data is written. For convenience of description, it is assumed that data is stored in each storage area in order from the bottom of the frame. That is, the current writing position corresponds to the upper end of the hatched portion.

As described above, while the event data is continuously written on the data volume, the index data is written at predetermined time intervals. The event data is not written on the index volume. Thus, the index data is accumulated in contiguous areas. On the other hand, the index data is intermittently stored in the data volume, with the event data interposed between the index data. Thus, during writing of the event data, when the index data is read from the data volume, a seek operation of a read-and-write head of the HDD occurs frequently.

A write address is separated from a read address. For this reason, when performing the seek operation, the head moves a long distance. For these reasons, in a situation where a writing load of the event data is high, it takes a long time to read the index data from the data volume.

In contrast, the server apparatus 130 stores the index data in the index volume. Thus, in a situation where a writing load of the event data is high, the index data is read from the index volume, and thus the index data may be read at high speed. The server apparatus 130 also stores the index data in the data volume. Thus, in a situation where a writing load of the event data is low, the index data is read from the high-performance data volume, and thus the index data may be read at high speed.

In this way, in the stream storage system 100 according to the second embodiment, the index data is stored in the data volume and the index volume, and thus the index data may be read at high speed. Hereinafter, hardware of the client apparatus 110 and the server apparatus 130, and a function of the server apparatus 130 that selects a suitable volume from which the index data is read at high speed, will be described.

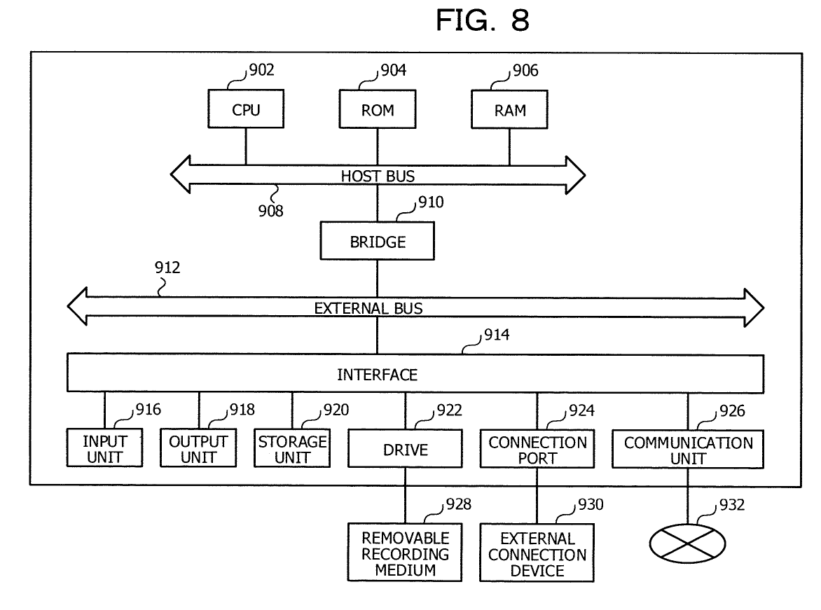

First, hardware of the client apparatus 110 will be described with reference to FIG. 8. FIG. 8 is a block diagram illustrating an example of the hardware capable of realizing functions of the client apparatus according to the second embodiment.

The functions of the client apparatus 110 may be realized by using, for example, hardware resources illustrated in FIG. 8. That is, the functions of the client apparatus 110 are realized by controlling the hardware illustrated in FIG. 8 based on a computer program.

As illustrated in FIG. 8, the hardware of the client apparatus 110 mainly includes a CPU 902, a read only memory (ROM) 904, a RAM 906, a host bus 908, and a bridge 910. Further, the hardware of the client apparatus 110 includes an external bus 912, an interface 914, an input unit 916, an output unit 918, a storage unit 920, a drive 922, a connection port 924, and a communication unit 926.

The CPU 902 functions as an arithmetic processing device or a control device. The CPU 902 controls the whole or a portion of operations of each component, based on various programs recorded in, for example, the ROM 904, the RAM 906, the storage unit 920, or a removable recording medium 928. The ROM 904 is an example of a storage device that stores a program which is read by the CPU 902 and data which is used for calculation. In the RAM 906, for example, a program to be read by the CPU 902, various parameters which change when the program is executed, and the like are temporarily or permanently stored.

These components are connected to each other via, for example, the host bus 908 capable of performing high-speed data transmission. On the other hand, the host bus 908 is connected to the external bus 912 having a relatively low data transmission speed, for example, via the bridge 910. As the input unit 916, for example, a mouse, a keyboard, a touch panel, or the like is used.

As the output unit 918, for example, a display device such as a cathode ray tube (CRT), a liquid crystal display (LCD), a plasma display panel (PDP), or an electro-luminescence display (ELD) is used. As the output unit 918, a printer or the like may be used.

The storage unit 920 is a device that stores various data. As the storage unit 920, for example, a magnetic storage device such as an HDD is used. As the storage unit 920, a semiconductor storage device such as an SSD or a RAM disk, an optical storage device, a magneto-optical storage device, or the like may be used.

The drive 922 is a device that reads information recorded on the removable recording medium 928 as a detachable recording medium or writes information on the removable recording medium 928. As the removable recording medium 928, for example, a magnetic disk, an optical disk, a magneto-optical disk, a semiconductor memory, or the like is used.

The connection port 924 is a port that connects with an external connection device 930, such as a universal serial bus (USB) port, an IEEE 1394 port, or a small computer system interface (SCSI). As the external connection device 930, for example, a printer or the like is used.

The communication unit 926 is a communication device that connects to the network 932. As the communication unit 926, for example, a communication circuit for wired LAN or wireless LAN, a communication circuit for wireless USB (WUSB), a communication circuit or a router for optical communication, a communication circuit or a router for asymmetric digital subscriber line (ADSL), or the like is used. The network 932 is a network that is connected to the communication unit 926 in a wire manner or in a wireless manner, and includes, for example, the Internet, a LAN, and the like.

The functions of the server apparatus 130 may also be realized by using the hardware illustrated in FIG. 8. Thus, a detailed description of the hardware of the server apparatus 130 will be omitted.

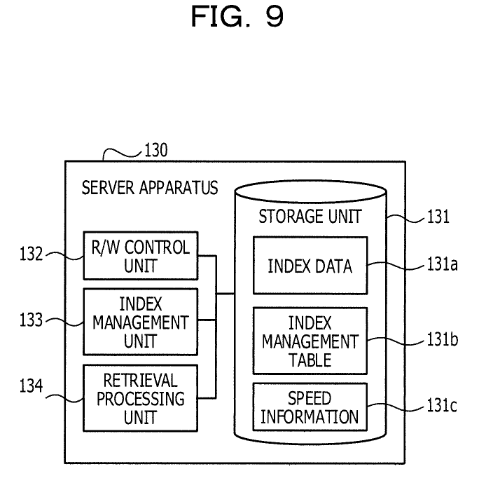

Next, the functions of the server apparatus 130 will be further described with reference to FIG. 9. FIG. 9 is a block diagram illustrating an example of the functions of the server apparatus according to the second embodiment.

As illustrated in FIG. 9, the server apparatus 130 includes a storage unit 131, an R/W control unit 132, an index management unit 133, and a retrieval processing unit 134. The function of the storage unit 131 may be realized by using the RAM 906, the storage unit 920, or the like. The functions of the R/W control unit 132, the index management unit 133, and the retrieval processing unit 134 may be realized by using the CPU 902 and the like.

The storage unit 131 stores index data 131a, an index management table 131b, and speed information 131c.

The index data 131a is data in which an attribute (for example, a source IP address) which is used for retrieving the event data and an event data ID of the event data having the attribute are correlated with each other (refer to FIG. 5).

The index management table 131b is a table in which a storage address of the index data 131a in the data volume and a period (time zone) for which the information (the attribute and the event data ID) is accumulated in the index data 131a are correlated with each other (refer to FIG. 6).

The speed information 131c is information such as a calculation equation for calculating a read speed R_{D} of the data in the data volume, and parameters A₁, A₂, A₃, and A₄ included in the calculation equation. The speed information 131c includes a read speed R_{I} of the data in the index volume. The calculation equation is given, for example, by the following equation (1).

$${R}_{D} = \frac{1}{{A}_{1} \cdot {W}_{D} + {A}_{2}} + {A}_{3} \cdot D + {A}_{4} \qquad ( 1 )$$

In the above equation (1), W_{D} is a write speed at the present time (at the time of evaluating the read speed R_{D}) on the data volume. The write speed W_{D} may be approximated by a flow amount of the event data which is written on the data volume (an amount of the write data per unit time).

D is a seek distance. The seek distance D is a distance between a write address and a read address. For example, in the case of reading the index data 131a from the data volume, the address at which the index data 131a is present is the read address, and the address indicating the current write position (refer to FIG. 7) is the write address.

The write address and the read address may be physical addresses or logical addresses. A calculation method of the parameters A₁, A₂, A₃, and A₄ will be described later.

The R/W control unit 132 controls reading and writing of the event data from and on the data volume. The R/W control unit 132 controls reading and writing of the index data 131a from and on the data volume and the index volume.

The index management unit 133 generates and updates the index data 131a. The index management unit 133 writes the index data 131a stored in the storage unit 131, on the data volume and the index volume, by controlling the R/W control unit 132. The index management unit 133 updates the index management table 131b, as the index management table 131b is written.

The retrieval processing unit 134 receives a retrieval request including a retrieval condition of the event data, from the client apparatus 110. The retrieval processing unit 134 reads the index data 131a satisfying the retrieval condition included in the retrieval request, from the data volume or the index volume, by controlling the R/W control unit 132. At this time, the retrieval processing unit 134 calculates a read speed R_{D} of the data in the data volume, using the speed information 131c. The retrieval processing unit 134 reads the index data 131a, from the volume with a high read speed.

The retrieval processing unit 134 refers to the index data 131a which is read. The retrieval processing unit 134 returns a list of event data IDs satisfying the retrieval condition included in the retrieval request, to the client apparatus 110. The client apparatus 110 selects, from the list, an event data ID corresponding to the desired event data. The client apparatus 110 transmits a read request indicating the selected event data ID, to the server apparatus 130.

The retrieval processing unit 134 receives the read request from the client apparatus 110. The retrieval processing unit 134 reads, from the data volume, the event data corresponding to the event data ID indicated by the read request, by controlling the R/W control unit 132. The retrieval processing unit 134 transmits the event data which is read, to the client apparatus 110.

As described above, the index data 131a is read from the volume with a higher read speed, and thus it is possible to shorten a time taken to retrieve the event data and to respond to the read request.

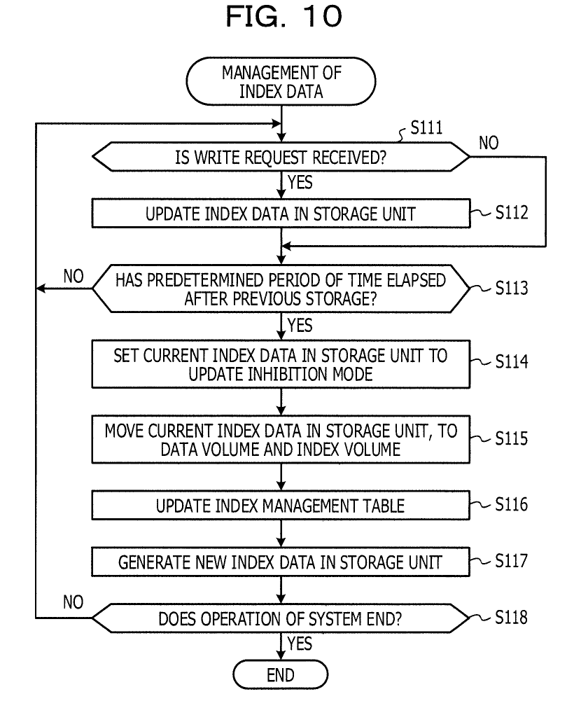

Next, a flow of processing executed by the server apparatus 130 will be described. First, a flow of processing related to management of the index data 131a that is executed by the index management unit 133 will be described with reference to FIG. 10. FIG. 10 is a flowchart illustrating a flow of processing related to management of the index data according to the second embodiment.

(S111) The index management unit 133 determines whether or not the server apparatus 130 receives a write request (refer to FIG. 4) from the client apparatus 110. The write request includes event data to be written, an event data ID for identifying the event data, and metadata indicating an attribute of the event data. In a case where a write request is received, the process proceeds to S112. On the other hand, in a case where a write request is not received, the process proceeds to S113.

(S112) The index management unit 133 extracts the event data ID and the metadata, from the write request received by the server apparatus 130. The index management unit 133 extracts, from the metadata, attribute information (for example, a source IP address) to be used for retrieving the event data. The index management unit 133 updates the index data 131a in the storage unit 131 based on the extracted event data ID and the extracted attribute information.

For example, it is assumed that the index data 131a having contents illustrated in FIG. 5 is stored in the storage unit 131, and that the client apparatus 110 transmits a write request including a source IP address “192.168.0.1” and an event data ID “11”. In this case, the index management unit 133 additionally writes “11” in a column of the event data ID corresponding to the source IP address “192.168.0.1” in the index data 131a.

(S113) The index management unit 133 determines whether or not a predetermined period of time (for example, one hour) elapses after the previous storage (the previous time when the index data 131a stored in the storage unit 131 is stored in the data volume and the index volume). In a case where the predetermined period of time elapses after the previous storage, the process proceeds to S114. On the other hand, in a case where the predetermined period of time does not elapse after the previous storage, the process proceeds to S111.

(S114) The index management unit 133 sets the current index data 131a in the storage unit 131 to update inhibition mode.

(S115) The index management unit 133 moves the current index data 131a in the storage unit 131, to the data volume and the index volume, by controlling the R/W control unit 132.

(S116) The index management unit 133 updates the index management table 131b (refer to FIG. 6) based on information related to the index data 131a which is moved to the data volume and the index volume in S115.

For example, it is assumed that, the index data 131a in which information of the event data which is stored in the data volume in the time zone “2016/3/31 04:00 to 05:00” is recorded, is moved to the data volume and the index volume. In a case where the storage destination of the index data 131a is “0x40004000 to 0x40008000”, the index management unit 133 additionally writes information of the time zone and the storage destination (storage destination address) in the index management table 131b.

(S117) The index management unit 133 cancels the update inhibition mode of the index data 131a, and generates new index data 131a in the storage unit 131.

(S118) In a case where the operation of the stream storage system 100 ends, a series of processes illustrated in FIG. 10 ends. On the other hand, in a case where the operation of the stream storage system 100 continues, the process proceeds to S111.

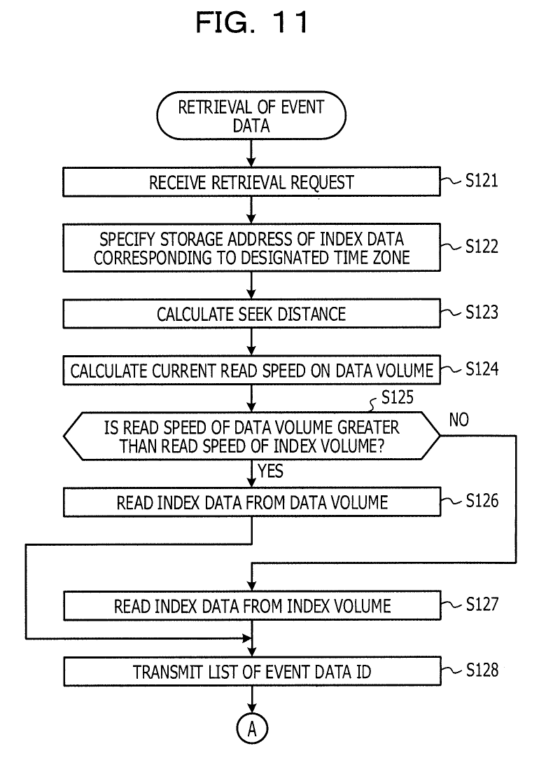

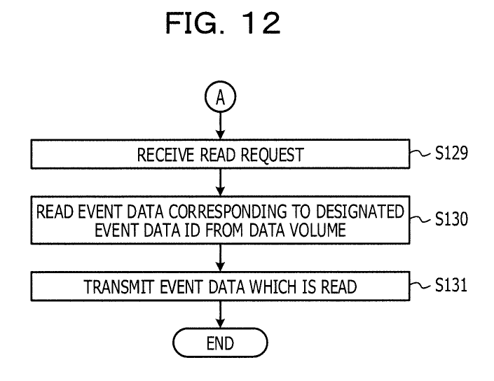

Next, a flow of processing related to retrieval of the event data by the retrieval processing unit 134 will be described with reference to FIG. 11 and FIG. 12. FIG. 11 is a first flowchart illustrating a flow of processing related to retrieval of the event data according to the second embodiment. FIG. 12 is a second flowchart illustrating a flow of processing related to retrieval of the event data according to the second embodiment.

(S121) The retrieval processing unit 134 receives a retrieval request from the client apparatus 110). The retrieval request includes information such as an attribute as a retrieval condition of the event data.

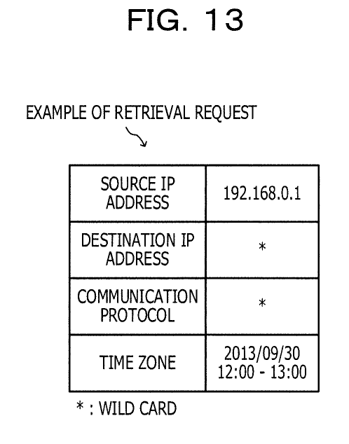

For example, as illustrated in FIG. 13, the retrieval request includes information such as a source IP address, a destination IP address, a communication protocol, and a time zone. FIG. 13 is a diagram illustrating an example of the retrieval request. In the example of FIG. 13, a value is set as a source IP address, and a wild card “*” is set as a destination IP address and a communication protocol. The wild card means that an arbitrary value meets a condition.

In the example of FIG. 13, a time zone in which information is accumulated in the index data 131a is further set. The retrieval request exemplified in FIG. 13 indicates a retrieval condition in which the source IP address is “192.168.0.1” and the time zone is “2013/09/30 12:00 to 13:00”. The retrieval request indicates that any condition is not imposed on the destination IP address and the communication protocol.

(S122) The retrieval processing unit 134 specifies a storage address of the index data 131a corresponding to the time zone (designated time zone) designated by the retrieval request, by referring to the index management table 131b. That is, the retrieval processing unit 134 specifies whether which area of the data volume is an area in which the index data 131a corresponding to the designated time zone is located.

(S123) The retrieval processing unit 134 detects a storage address (read address) indicating a start point of the area in which the index data 131a is stored, and an address (write address) of the data volume on which event data writing processing is executed. The retrieval processing unit 134 calculates a difference (seek distance D) between the write address and the read address. For example, when the write address is X_{W} and the read address is X_{D}, the retrieval processing unit 134 calculates |X_{D}-X_{W}|. The retrieval processing unit 134 sets the calculation result as the seek distance D (| . . . | indicates an absolute value).

(S124) The retrieval processing unit 134 obtains the current write speed W_{D} from the current flow amount of the event data (the amount of write data per unit time) on the data volume. Then, based on the speed information 131c stored in the storage unit 131 and the seek distance D calculated in S123, the retrieval processing unit 134 calculates the current read speed R_{D} on the data volume according to the above equation (1).

(S125) The retrieval processing unit 134 refers to the read speed R_{I} of the index volume that is stored in advance in the storage unit 131. The retrieval processing unit 134 determines whether or not the read speed R_{D} of the data volume is greater than R_{I}. In a case where R_{D} is greater than R_{I}, the process proceeds to S126. On the other hand, in a case where R_{D} is not greater than R_{I}, the process proceeds to S127.

Unlike the data volume on which the event data is typically written, in the index volume, the writing load of the event data does not affect the read speed of the index data 131a. Thus, the retrieval processing unit 134 may execute the processing of reading the data from the index volume in advance, and use the read speed R_{I} measured when executing the processing as it is for the determination.

(S126) The retrieval processing unit 134 reads the index data 131a from the data volume based on the storage address specified in S122, by controlling the R/W control unit 132. When the process of S126 is completed, the process proceeds to S128.

(S127) The retrieval processing unit 134 reads the index data 131a from the index volume by controlling the R/W control unit 132.

(S128) The retrieval processing unit 134 extracts, from the index data 131a which is read, a set of the event data IDs corresponding to the attribute (source IP address in the example of FIG. 13) of the event data that is designated by the retrieval request. The retrieval processing unit 134 transmits a list of the event data IDs included in the extracted set, to the client apparatus 110.

(S129) The client apparatus 110, which receives the list of the event data IDs, selects a desired event data ID from the received list, and transmits a read request designating the selected event data ID, to the server apparatus 130. The retrieval processing unit 134 receives the read request from the client apparatus 110.

(S130 and S131) The retrieval processing unit 134 reads, from the data volume, the event data corresponding to the event data ID designated by the read request (designated event data ID), by controlling the R/W control unit 132. The retrieval processing unit 134 transmits the event data which is read, to the client apparatus 110. When the process of S131 is completed, a series of processes illustrated in FIG. 11 and FIG. 12 ends.

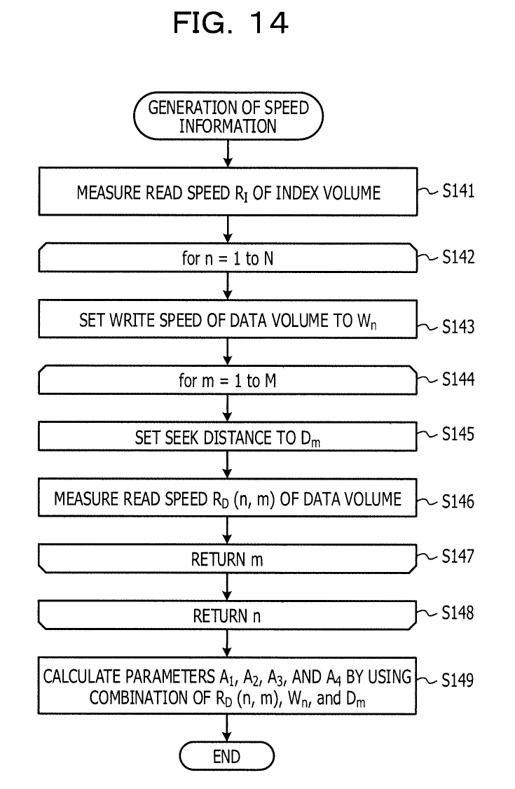

Next, a flow of processing related to the generation of the speed information 131c will be described with reference to FIG. 14. FIG. 14 is a flowchart illustrating a flow of processing related to the generation of the speed information according to the second embodiment.

(S141) The retrieval processing unit 134 measures the read speed R_{I} of the index volume. For example, the retrieval processing unit 134 reads a certain amount of data from the index volume. The retrieval processing unit 134 calculates the amount of the read data per unit time (read speed R_{I}), based on the time taken to read the data. The retrieval processing unit 134 stores the read speed R_{I} in the index volume, in the storage unit 131.

(S142 to S148) The retrieval processing unit 134 executes processes of steps S142 to S148 while changing a parameter n from 1 to N. Here, N is an integer of one or more. The product of M and N to be described later is four or more. For example, M is set to 2, and N is set to 2.

(S143) The retrieval processing unit 134 sets the write speed of the data volume to Wₙ. Here, the write speed Wₙ (n=1, . . . , N) is the flow amount of the data on the data volume (the amount of write data per unit time), and a value of the write speed is determined in advance. For example, the write speed Wₙ is determined based on the flow amount of the actually observed stream data. W₁, . . . , W_{N} are set to different values from each other.

(S144 to S147) The retrieval processing unit 134 executes processes of steps S144 to S147 while changing a parameter m from 1 to M. Here, M is an integer of one or more. The product of M and N is four or more.

(S145) The retrieval processing unit 134 sets the seek distance to Dₘ. Here, Dₘ may be arbitrarily set. D₁, . . . , D_{M} are set to positive values different from each other. The seek distance Dₘ which is set here is a distance between the address at which the data is written on the data volume and the address at which the data is read from the data volume, when measuring the read speed R_{D} (n, m).

(S146) The retrieval processing unit 134 controls the R/W control unit 132. The retrieval processing unit 134 writes the data on the data volume at the write speed Wₙ, and reads a predetermined amount of data at an address away from the write address by the seek distance Dₘ. The retrieval processing unit 134 measures the time taken to read the data. The retrieval processing unit 134 calculates the read speed R_{D} (n, m), based on the measured time and the predetermined amount of the data. That is, the retrieval processing unit 134 simultaneously reads and writes data from and on the data volume, and measures the read speed R_{D} (n, m).

(S149) When the processes of steps S142 to S148 end, the read speed R_{D} (n, m) is obtained for each combination of the parameters n and m. By substituting the combination of R_{D} (n, m), Wₙ, and Dₘ into the above equation (1), N×M equations with parameters A₁, A₂, A₃, and A₄ as unknowns are obtained.

The retrieval processing unit 134 calculates the parameters A₁, A₂, A₃, and A₄ by simultaneously solving the N×M equations. The retrieval processing unit 134 stores the calculated parameters A₁, A₂, A₃, and A₄ in the storage unit 131. When the process of S149 is completed, a series of processes illustrated in FIG. 14 ends.

In the above description, a method of expressing the storage address of the index data 131a in the data volume by a physical address or a logical address, is described. The method of expressing the storage address is arbitrary. In a case where the index data 131a is directly written on a block device, a physical address may be used. In a case where the data volume is a logical volume, it is easier to use a logical address for an expression of the storage address.

A single data file which may sufficiently store the index data 131a may be generated in the data volume, and an offset from the start address of the data file may be used for an expression of the storage address. For example, a virtual volume may be generated in a logical volume, and an address indicating a position in the virtual volume may be used for an expression of the storage address. Such a modification also falls within a technical scope of the second embodiment.

In the above description, for convenience of explanation, a case where the data volume has a striping configuration has been described. The data volume may have a configuration of another RAID level such as RAID5. Here, since the data volume is a storage area which is used for accumulating the event data (stream data), the data volume is preferably set to a RAID level which attaches importance to the write speed. Such a modification also falls within a technical scope of the second embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data referring method executed by a processor included in an information processing apparatus coupled to a network, a first memory, and a second memory, the data referring method comprising:
writing stream data received through the network into the first memory;
writing index data used for retrieving the stream data into the first memory and writing the index data into the second memory;
specifying a memory of which access speed is higher from among the first memory and the second memory when reading the index data; and
reading the index data from the specified memory.

2. The data referring method according to claim 1,
wherein the specifying includes specifying the memory based on a distance between an address of the stream data being written on the first memory and an address of the index data when reading the index data.

3. The data referring method according to claim 2,
wherein the specifying includes specifying the memory based on a flow amount of the stream data being written on the first memory and the distance when reading the index data.

4. The data referring method according to claim 3, further comprising:
storing information of a read speed of the data in the second memory and information of an evaluation equation for evaluating a read speed of the data in the first memory based on the flow amount of the stream data and the distance,
wherein the specifying includes specifying the memory based on a result of comparison between the read speed of the index data in the first memory that is calculated based on the evaluation equation and the read speed of the data in the second memory when reading the index data.

5. The data referring method according to claim 1,
wherein the access speed is a read speed when reading the index data.

6. The data referring method according to claim 1,
wherein reading performance of the second memory is lower than reading performance of the first memory under a same storage situation.

7. The data referring method according to claim 6,
wherein the specifying includes specifying the memory when the stream data is stored in the first memory, and the index data is stored in the first memory and the second memory.

8. The data referring method according to claim 1,
wherein the first memory intermittently stores a plurality of pieces of stream data in storage areas of the first memory, with the index data interposed between the plurality of pieces of stream data, and
wherein the second memory consecutively stores a plurality of pieces of index data in storage areas of the second memory.

9. The data referring method according to claim 1,
wherein the sequential writing of the stream data on the first memory includes writing event data indicating a set of data having a common attribute extracted from the stream data.

10. The data referring method according to claim 9,
wherein the attribute includes a source address, a destination address, and information indicating a protocol type.

11. The data referring method according to claim 1,
wherein the reading includes reading the index data during writing the stream data into the first memory.

12. The data referring method according to claim 1,
wherein the stream data is received sequentially from the network.

13. An information processing apparatus comprising:
a memory; and
a processor coupled to the memory and configured to:
write stream data received through the network into the first memory;
write index data used for retrieving the stream data into the first memory and write the index data into the second memory;
specify a memory of which access speed is higher from among the first memory and the second memory when reading the index data; and
read the index data from the specified memory.

14. A non-transitory computer-readable storage medium storing a program that causes a processor included in an information processing apparatus to execute a process, the process comprising:
writing stream data received through the network into the first memory;
writing index data used for retrieving the stream data into the first memory and writing the index data into the second memory;
specifying a memory of which access speed is higher from among the first memory and the second memory when reading the index data; and
reading the index data from the specified memory.
